(19) United States
(12) Patent Application Publication
(10) Pub. No.: US 2016/0237388 A1
(43) Pub. Date: Aug. 18, 2016

(54) Method for Removing Impurities from a Liquid by Attracting the Impurities through Absorption and Adsorption

(71) Applicant: Sheila Walberg-O'Neil, Conway, SC (US)

(72) Inventor: Sheila Walberg-O'Neil, Conway, SC (US)

(21) Appl. No.: 15/010,823

(22) Filed: Jan. 29, 2016

Related U.S. Application Data
(60) Provisional application No. 62/115,431, filed on Feb. 12, 2015.

(51) Int. Cl. C12H 1/04; C02F 1/28

(52) U.S. Cl. CPC C12H 1/04; C02F 1/283

(57) ABSTRACT

A method for removing impurities from a liquid by attracting the impurities through absorption and adsorption allows impurities to be removed from a quantity of liquid that is contained within a vessel. A required number of purifier devices each including a liquid-permeable sleeve and a quantity of carbon is placed into the vessel and impurities in the quantity of liquid are drawn into the liquid-permeable sleeve and adhered to the quantity of activated carbon through adsorption and absorption. The quantity of carbon is converted to a quantity of activated carbon by actuating the required number of purifier devices within warm water prior to submerging the required number of purifier devices within the quantity of liquid. The required number of purifier devices may be left within the vessel indefinitely or removed from the vessel and cleaned for reuse.

The current application claims a priority to the U.S. Provisional Patent application Ser. No. 62/115,431 filed on Feb. 12, 2015.

### FIELD OF THE INVENTION

The present invention relates generally to a method for purifying a liquid. More specifically, the present invention is a method for removing impurities from a liquid by attracting the impurities through absorption and adsorption.

### BACKGROUND OF THE INVENTION

One of the most significant contributing factors to an alcohol hangover is the presence of congeners, chemicals, additives, and other impurities in many alcoholic beverages. Although ethanol alone is capable of causing hangovers, the presence of these impurities within alcoholic beverages exacerbates the severity of hangovers. Congeners are produced during the fermentation of alcoholic beverages and include numerous chemicals that can alter the taste and aroma of the alcoholic beverages. Low quality alcoholic beverages in particular have a high concentration of congeners, chemicals, additives, and other impurities relative to ethanol. While the presence of impurities is most often simply an annoyance to consumers of alcoholic beverages, certain types of impurities may hinder or altogether prevent the consumption of some alcoholic beverages. One prominent example is wine which often contains sulfites that serve as preservatives to prevent oxidation and bacterial growth. Sulfites often occur naturally in wine, but may be added in larger amounts as well. Sulfites can cause an allergic reaction in some people who are thus unable to consume wine. As such, a means of removing impurities from alcoholic beverages is desirable.

The present invention is a method for removing impurities from a liquid by attracting the impurities through absorption and adsorption. A purifier device is placed into a liquid that is to be purified. The present invention may be utilized with various types of liquids including, but not limited to, water, liquor, and wine. Within the context of the present invention, the liquid to be purified does not flow through the purifier device as in a filter. Rather, the purifier device is placed into the liquid and functions similar to a magnet. Impurities within the liquid are drawn into the purifier device and removed from the liquid by absorption and adsorption. The purifier device may be left in the liquid for an extended period of time if needed.

### BRIEF DESCRIPTION OF THE DRAWINGS

FIG. 1 is a flowchart depicting the overall process followed by the present invention.

FIG. 2 is a flowchart depicting the secondary process followed by the present invention when determining the required number of purifier devices.

FIG. 3 is a flowchart depicting the secondary process followed by the present invention when the impurities are removed from the quantity of liquid.

FIG. 4 is a flowchart depicting the secondary process followed by the present invention when the quantity of liquid is a wine.

FIG. 5 is a flowchart depicting the secondary process followed by the present invention when the quantity of liquid is a liquor.

FIG. 6 is a flowchart depicting the secondary process followed by the present invention when the quantity of liquid is water within a water boiling apparatus.

FIG. 7 is a flowchart depicting the secondary process followed by the present invention when the required number of purifier devices is cleaned.

FIG. 8 is a flowchart depicting the secondary process followed by the present invention when the liquid-permeable sleeve is composed of a dimensionally-stable material at a temperature range of −35° F. to 390° F.

FIG. 9 is a flowchart depicting the secondary process followed by the present invention when the quantity of carbon is approximately 10 grams for each of the plurality of purifier devices.

FIG. 10 is a diagram depicting the mechanism of action utilized by the present invention.

### DETAIL DESCRIPTIONS OF THE INVENTION

All illustrations of the drawings are for the purpose of describing selected versions of the present invention and are not intended to limit the scope of the present invention.

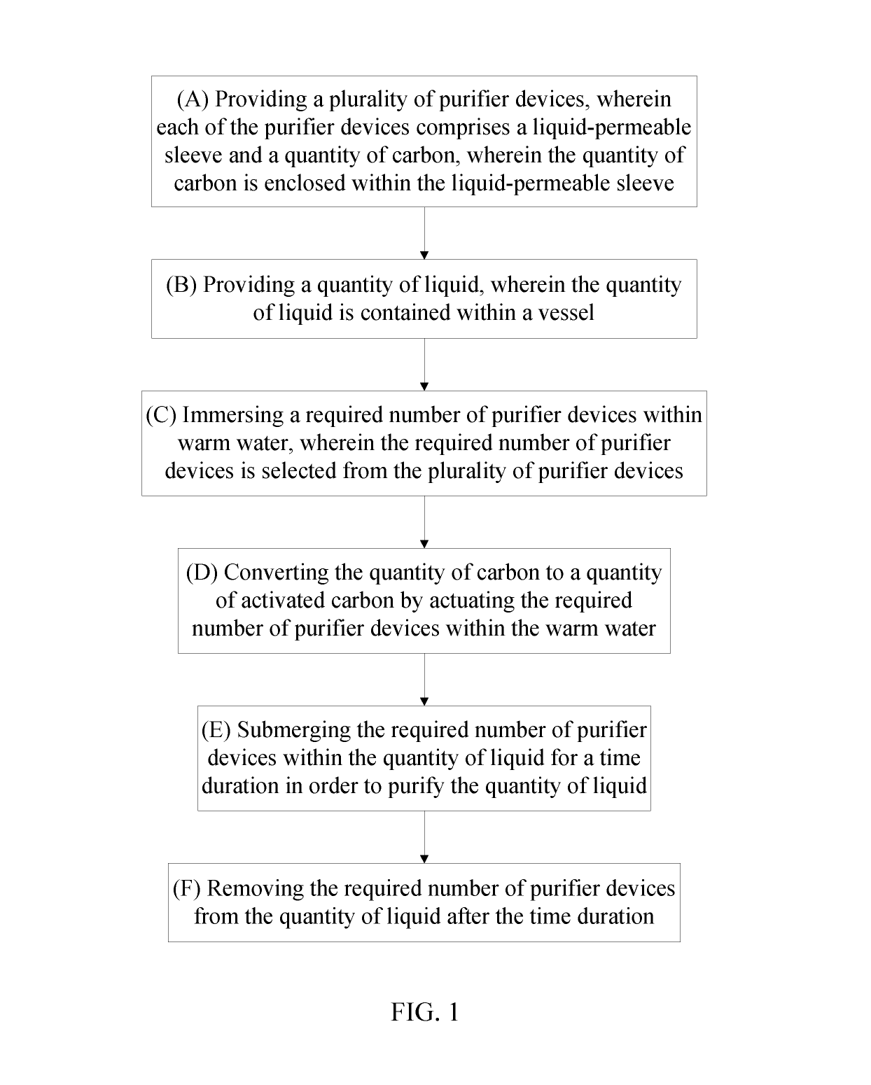

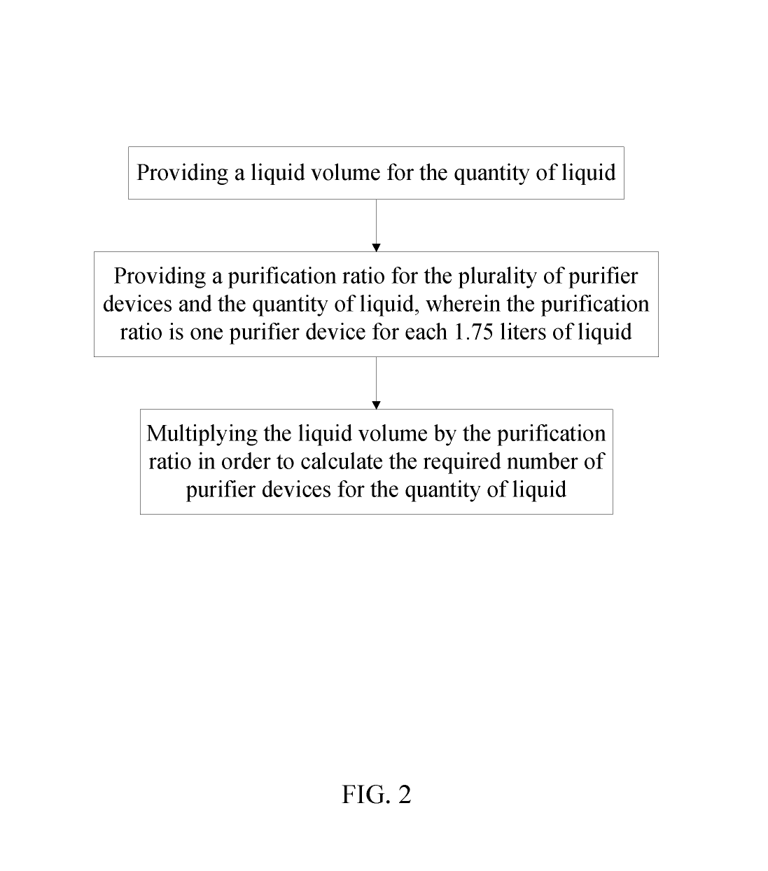

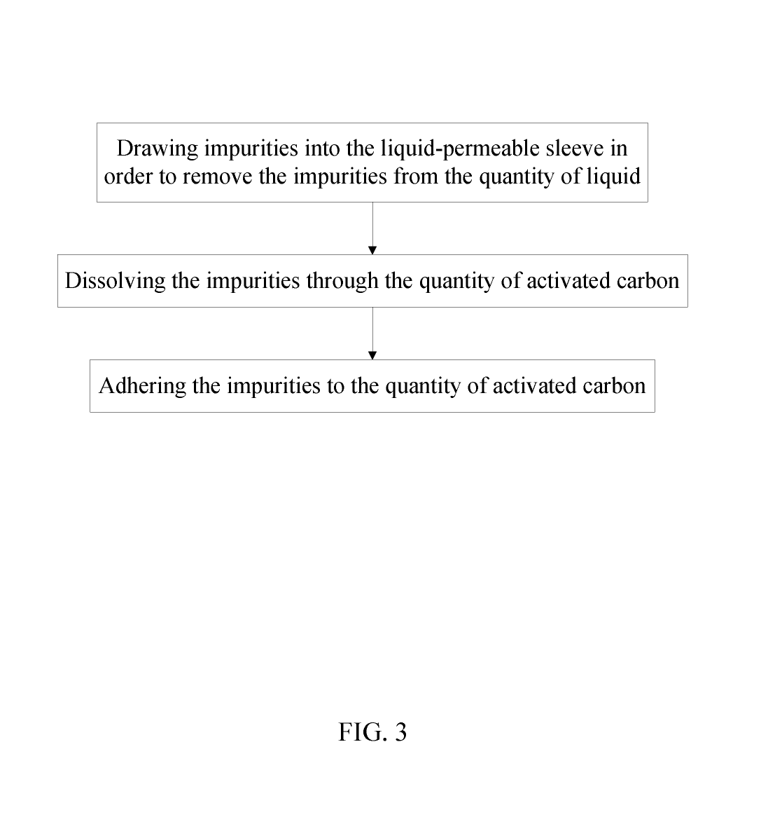

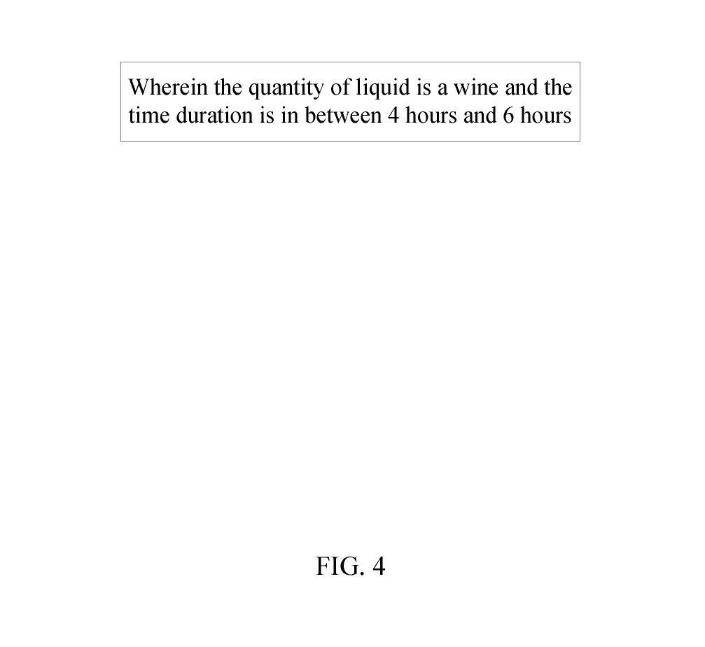

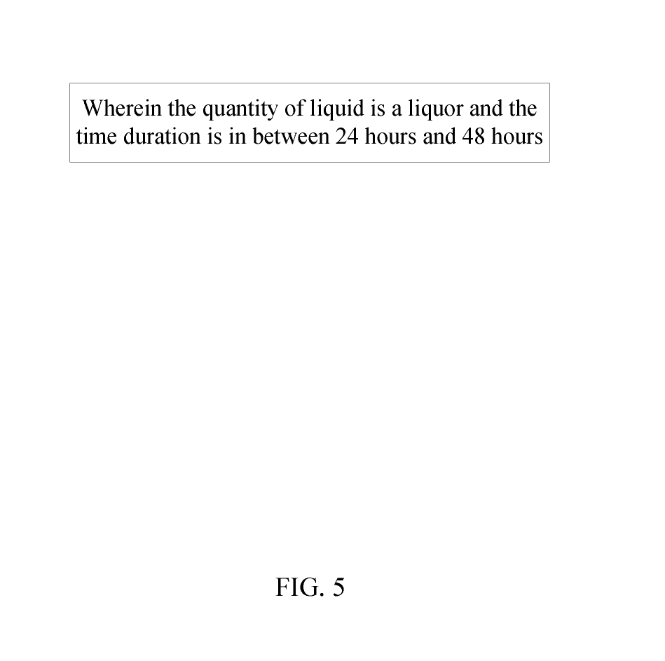

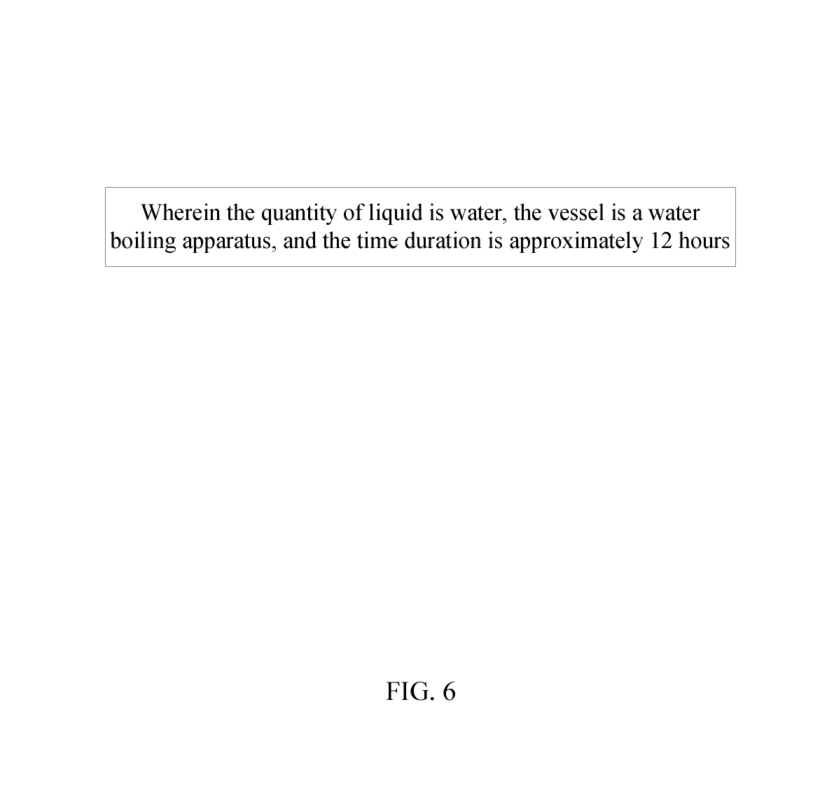

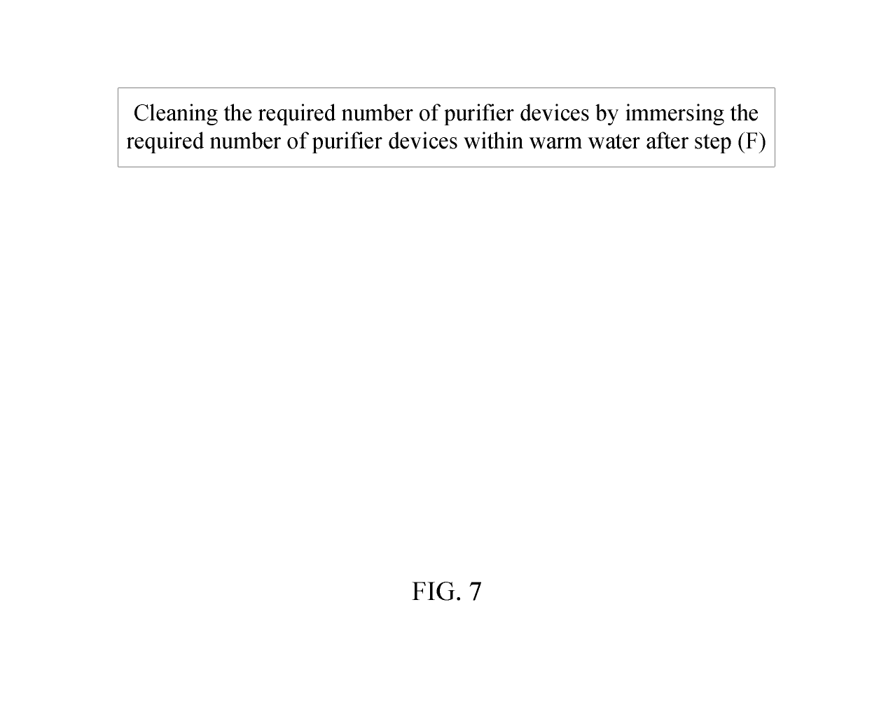

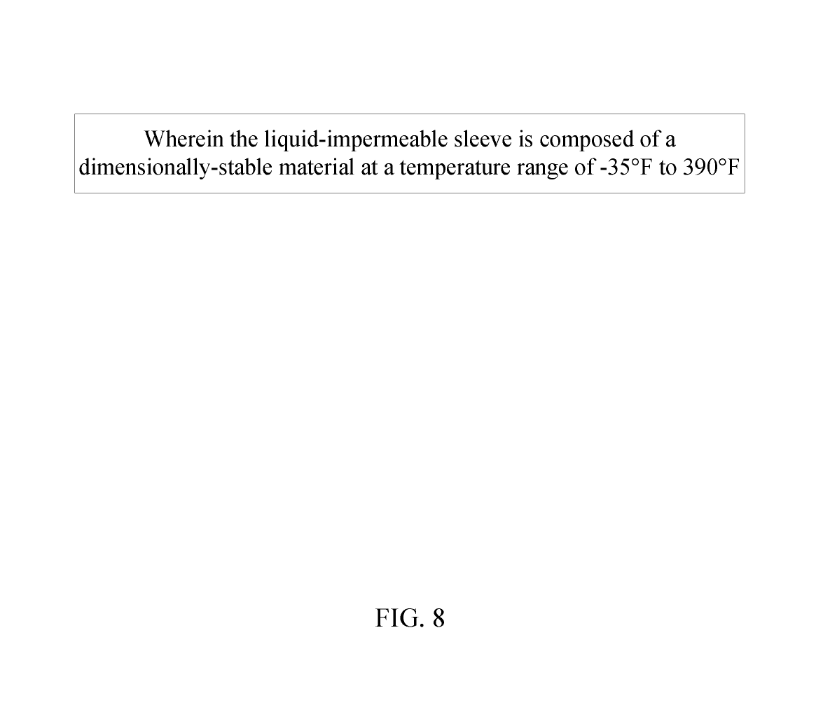

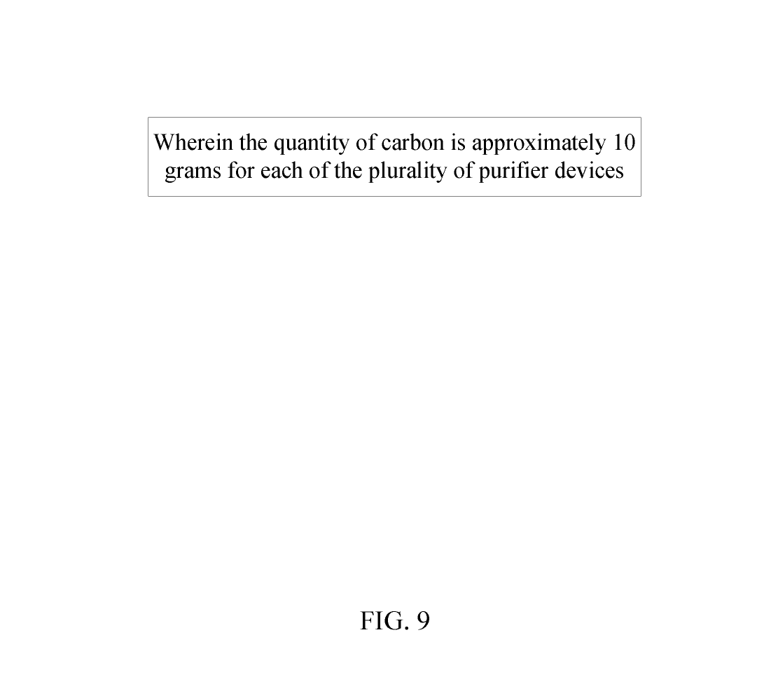

The present invention is a method for removing impurities from a liquid by attracting the impurities through absorption and adsorption. The present invention enables the removal of impurities such as, but not limited to, congeners, chemicals, and additives that are present in alcoholic beverages such as wine and liquor. However, the present invention may be utilized with any liquid such as water. The overall process followed by the present invention is shown in FIG. 1 while secondary processes followed by the present invention are shown in FIGS. 2-9.

With reference to FIG. 1, a plurality of purifier devices is provided that is utilized in order to purify a quantity of liquid. The quantity of liquid is contained within a vessel such as a bottle. Each of the purifier devices comprises a liquid-permeable sleeve and a quantity of carbon and the quantity of carbon is enclosed within the liquid-permeable sleeve. The liquid-permeable sleeve serves to contain the quantity of carbon and minimize the escape of carbon dust from within the liquid-permeable sleeve. The liquid-permeable sleeve additionally enables easy handling of the plurality of purifier devices and enables the plurality of purifier devices to be placed into the quantity of liquid. In the preferred embodiment of the present invention, the liquid-permeable sleeve is a tubular sleeve with two close ends that prevent the quantity of carbon from escaping from within the liquid-permeable sleeve. Because the liquid-permeable sleeve may be subjected to both high and low temperatures during use, the liquid-permeable sleeve is preferably composed of a dimensionally-stable material at a temperature range of −35° F. to −390° F. In the preferred embodiment of the present invention, the material of the liquid-permeable sleeve is polyester fiber. The quantity of carbon serves to purify the quantity of liquid through adsorption. In the preferred embodiment of the present invention, the quantity of carbon is approximately 10 grams for each of the plurality of purifier devices.

A required number of purifier devices is immersed within warm water in order to prepare the required number of purifier devices for use in purifying the quantity of liquid. The required number of purifier devices is selected from the plurality of purifier devices. The required number of purifier devices is directly proportion to a liquid volume for the quantity of liquid. A purification ratio for the plurality of purifier devices is utilized in order to determine the required number of purifier devices in order to purify the quantity of liquid. In the preferred embodiment of the present invention, the purification ratio is one purifier device for each 1.75 liters of liquid. The liquid volume is multiplied by the purification ratio in order to calculate the required number of purifier devices for the quantity of liquid.

After the required number of purifier devices is immersed within warm water, the quantity of carbon is converted to a quantity of activated carbon. The required number of purifier devices is actuated within the warm water. The required number of purifier devices may be rubbed, squeezed, and shaken within the warm water in order to convert the quantity of carbon to the quantity of activated carbon. The required number of purifier devices is then ready to purify the quantity of liquid.

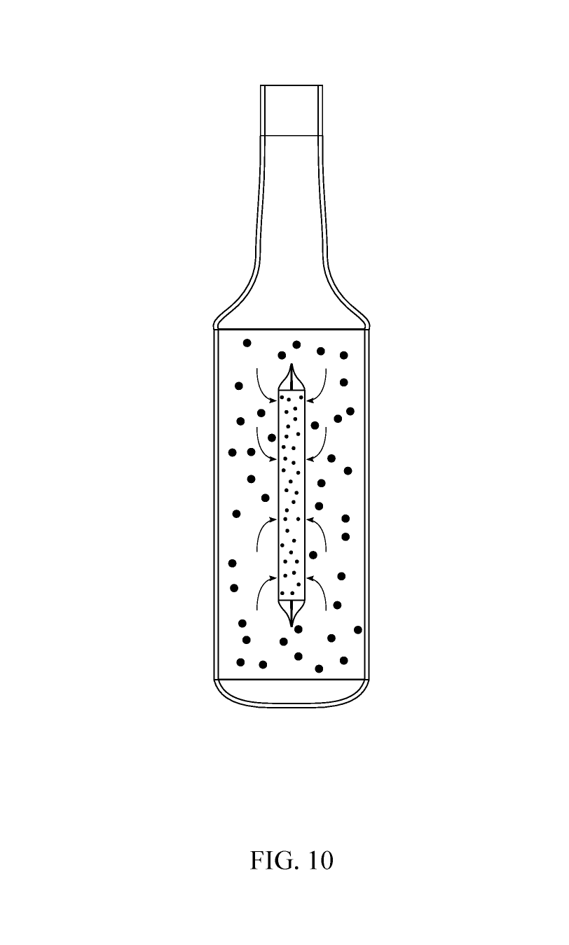

The required number of purifier devices is submerged within the quantity of liquid for a time duration in order to purify the quantity of liquid. This may be done by simply placing the required number of purifier devices into the vessel in which the quantity of liquid is contained. The quantity of activated carbon is put into contact with the quantity of liquid, but is not able to disperse into the quantity of liquid. In the preferred embodiment of the present invention, the quantity of activated carbon utilizes absorption and adsorption to purify the quantity of liquid. The present invention does not function in a manner similar to conventional liquid filters that involve a liquid being passed through a filter before the filtered liquid is deposited into a reservoir. Rather, each of the plurality of purifier devices functions similar to a magnet that draws impurities within the quantity of liquid toward the quantity of activated carbon as shown in FIG. 10. Impurities are drawn into the liquid-permeable sleeve in order to remove the impurities from the quantity of liquid. The material of the liquid-permeable sleeve enables the impurities within the quantity of liquid to be drawn through the liquid-permeable sleeve. The impurities are dissolved within the liquid-permeable sleeve through the quantity of activated carbon in order to facilitate adhesion of the impurities to the quantity of activated carbon. This may be accomplished by impregnating the quantity of activated carbon with chemicals in order to distribute chemicals on the surface of the quantity of activated carbon. Chemisorption may thus be utilized to dissolve the impurities and aid in adhering the impurities to the quantity of activated carbon. After the impurities are dissolved, the impurities are adhered to the quantity of activated carbon in order to fully remove the impurities from the quantity of liquid.

The present invention may be utilized to purify a variety of liquids. The quantity of time during which the required number of purifier devices is able to remove impurities from the quantity of liquid varies depending on the type of the quantity of liquid. If the quantity of liquid is a wine, the time duration is in between 4 hours and 6 hours. The present invention is particularly beneficial for removing sulfites that are commonly found in wines. If the quantity of liquid is a liquor, the time duration is in between 24 hours and 48 hours. The present invention is effective for purifying water as well for an extended period of time. If the quantity of liquid is water contained within a vessel such as a water boiling apparatus, the time duration is approximately 12 hours. However, the required number of purifier devices may be left in the vessel for approximately 90 days during which the vessel may be refilled multiple times.

After the impurities have been removed from the quantity of liquid and the quantity of liquid has been purified, the required number of purifier devices is removed from the quantity of liquid after the time duration. The required number of purifier devices may be reused by cleaning the required number of purifier devices by immersing the required number of purifier devices within warm water after the required number of purifier devices has been removed from the quantity of liquid. The required number of purifier devices may thus be utilized in multiple bottles and other types of vessels. Alternatively, the required number of purifier devices may be left within a single vessel for an indefinite period of time.

Although the present invention has been explained in relation to its preferred embodiment, it is understood that many other possible modifications and variations can be made without departing from the spirit and scope of the present invention as hereinafter claimed.

What is claimed is:

1. A method for removing impurities from a liquid by attracting the impurities through absorption and adsorption, the method comprises the steps of:
(A) providing a plurality of purifier devices, wherein each of the purifier devices comprises a liquid-permeable sleeve and a quantity of carbon, wherein the quantity of carbon is enclosed within the liquid-permeable sleeve;
(B) providing a quantity of liquid, wherein the quantity of liquid is contained within a vessel;
(C) immersing a required number of purifier devices within warm water, wherein the required number of purifier devices is selected from the plurality of purifier devices;
(D) converting the quantity of carbon to a quantity of activated carbon by actuating the required number of purifier devices within the warm water;
(E) submerging the required number of purifier devices within the quantity of liquid for a time duration in order to purify the quantity of liquid; and
(F) removing the required number of purifier devices from the quantity of liquid after the time duration.

2. The method for removing impurities from a liquid by attracting the impurities through absorption and adsorption as claimed in claim 1, the method comprises the steps of:
providing a liquid volume for the quantity of liquid;
providing a purification ratio for the plurality of purifier devices and the quantity of liquid, wherein the purification ratio is one purifier device for each 1.75 liters of liquid; and
multiplying the liquid volume by the purification ratio in order to calculate the required number of purifier devices for the quantity of liquid.

3. The method for removing impurities from a liquid by attracting the impurities through absorption and adsorption as claimed in claim 1, the method comprises the steps of:
drawing impurities into the liquid-permeable sleeve in order to remove the impurities from the quantity of liquid;
dissolving the impurities through the quantity of activated carbon; and
adhering the impurities to the quantity of activated carbon.

4. The method for removing impurities from a liquid by attracting the impurities through absorption and adsorption as claimed in claim 1, wherein the quantity of liquid is a wine and the time duration is in between 4 hours and 6 hours.

5. The method for removing impurities from a liquid by attracting the impurities through absorption and adsorption as claimed in claim 1, wherein the quantity of liquid is a liquor and the time duration is in between 24 hours and 48 hours.

6. The method for removing impurities from a liquid by attracting the impurities through absorption and adsorption as claimed in claim 1, wherein the quantity of liquid is water, the vessel is a water boiling apparatus, and the time duration is approximately 12 hours.

7. The method for removing impurities from a liquid by attracting the impurities through absorption and adsorption as claimed in claim 1, the method comprises the step of:
cleaning the required number of purifier devices by immersing the required number of purifier devices within warm water after step (F).

8. The method for removing impurities from a liquid by attracting the impurities through absorption and adsorption as claimed in claim 1, wherein the liquid-impermeable sleeve is composed of a dimensionally-stable material at a temperature range of −35° F. to 390° F.

9. The method for removing impurities from a liquid by attracting the impurities through absorption and adsorption as claimed in claim 1, wherein the quantity of carbon is approximately 10 grams for each of the plurality of purifier devices.
